(19) United States
(12) Patent Application Publication
(10) Pub. No.: US 2009/0025904 A1
(43) Pub. Date: Jan. 29, 2009

(54) Air conditioning system

(75) Inventors: Takahrio Tokunaga, Kosai-city (JP); Hitomi Asano, Kariya-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/220,175

(22) Filed: Jul. 22, 2008

(30) Foreign Application Priority Data
Jul. 23, 2007 (JP) 2007-190898

(51) Int. Cl. F25B 29/00; F28D 15/00; G05D 23/00

(52) U.S. Cl. 165/58; 165/104.34; 165/287

(57) ABSTRACT

An air conditioning system for conditioning air in a room includes an air-conditioner casing, an air blower, a cooling heat exchanger, and a heating heat exchanger. The air-conditioner casing causes air to flow toward the room. The air blower includes an electric motor and an impeller rotated by the electric motor to generate air flowing toward the room. The cooling heat exchanger is provided in the air-conditioner casing for cooling air. The heating heat exchanger is provided in the air-conditioner casing for heating air. The air blower is provided downstream of the cooling heat exchanger and the heating heat exchanger in a flow direction of air. Air in the room is conditioned based on cold air cooled by the cooling heat exchanger and hot air heated by the heating heat exchanger. The electric motor is provided outside the air-conditioner casing and is cooled by room air.

### CROSS REFERENCE TO RELATED APPLICATION

This application is based on and incorporates herein by reference Japanese Patent Application No. 2007-190898 filed on Jul. 23, 2007. This application is also related to U.S. application Ser. No. to be assigned, entitled “AIR CONDITIONING SYSTEM” filed on Jul. 22, 2008.

### BACKGROUND OF THE INVENTION

1. Field of the Invention

The present invention relates to an air conditioning system that adjusts temperature of air by using a cooling heat exchanger and a heating heat exchanger.

2. Description of Related Art

Conventionally, in the above air conditioning system, an electric air blower is provided within an air-conditioner casing and is provided downstream of a cooling heat exchanger and a heating heat exchanger in a flow direction of air. In the above configuration, cold air flowing from the cooling heat exchanger and hot air flowing from the heating heat exchanger flow toward the electric air blower and are mixed with each other. Then, mixed air is blown by the electric air blower toward a room through an outlet port as air for air conditioning (see, for example, JP-A-61-115709).

In the above configuration, there is provided a temperature adjustment door that adjusts a temperature of air that is blown through the outlet port by adjusting a ratio of a flow amount of (a) cold air and (b) hot air. In the above, the cold air flows from the cooling heat exchanger toward the electric air blower, and the hot air flows from the heating heat exchanger toward the electric air blower.

Inventors studied cooling of an electric motor of the electric air blower according to the above air conditioning system of JP-A-61-115709.

A temperature adjustment door is able to minimize air flow of the cold air flowing from the cooling heat exchanger toward the electric air blower and is able to maximize air flow of the hot air flowing from the heating heat exchanger toward the electric air blower such that the operational mode of the system is set as a maximum heating mode. Then, a temperature of the air blown to the room (or passenger compartment) through the outlet port is made to be a maximum temperature.

Then, in a case, where the electric motor of the electric air blower is provided in an air passage downstream of the heating heat exchanger in the air flow direction, hot air of high temperature from the heating heat exchanger flows around the electric motor of the electric air blower when the maximum heating mode is set. Accordingly, the electric motor of the electric air blower is not sufficiently cooled disadvantageously.

### SUMMARY OF THE INVENTION

The present invention is made in view of the above disadvantages. Thus, it is an objective of the present invention to address at least one of the above disadvantages.

To achieve the objective of the present invention, there is provided an air conditioning system for conditioning air in a room, which system includes an air-conditioner casing, an air blower, a cooling heat exchanger, and a heating heat exchanger. The air-conditioner casing causes air to flow toward the room. The air blower includes an electric motor and an impeller, which is rotated by the electric motor to generate air flowing toward the room. The cooling heat exchanger is provided in the air-conditioner casing for cooling air. The heating heat exchanger is provided in the air-conditioner casing for heating air. The air blower is provided downstream of the cooling heat exchanger and the heating heat exchanger in a flow direction of air. Air in the room is conditioned based on cold air cooled by the cooling heat exchanger and hot air heated by the heating heat exchanger. The electric motor is provided outside the air-conditioner casing and is cooled by room air.

### BRIEF DESCRIPTION OF THE DRAWINGS

The invention, together with additional objectives, features and advantages thereof, will be best understood from the following description, the appended claims and the accompanying drawings in which:

FIG. 1 is a cross-sectional view of a room unit assembly of an air conditioning system according to a first embodiment of the present invention viewed in a vehicle left-right direction;

FIG. 2 is a cross-sectional view taken along line II-II in FIG. 1;

FIG. 3 is a cross-sectional perspective view showing an inside of the room unit assembly of the first embodiment;

FIG. 4 is a cross-sectional view showing an inside of a room unit assembly according to a second embodiment of the present invention viewed from a vehicle rear side;

FIG. 5 is a cross-sectional view showing an inside of a room unit assembly according to a third embodiment of the present invention viewed from the vehicle rear side;

FIG. 6 is a cross-sectional view showing an inside of a room unit assembly according to a fourth embodiment of the present invention viewed from the vehicle rear side;

FIG. 7 is a cross-sectional view of a room unit assembly of an air conditioning system according to a fifth embodiment of the present invention viewed in a vehicle left-right direction;

FIG. 8 is a cross-sectional view taken along line VIII-VIII in FIG. 7; and

FIG. 9 is a cross-sectional view showing a room unit assembly of an air conditioning system according to a modified example of the present invention.

### DETAILED DESCRIPTION OF PREFERRED EMBODIMENTS

### First Embodiment

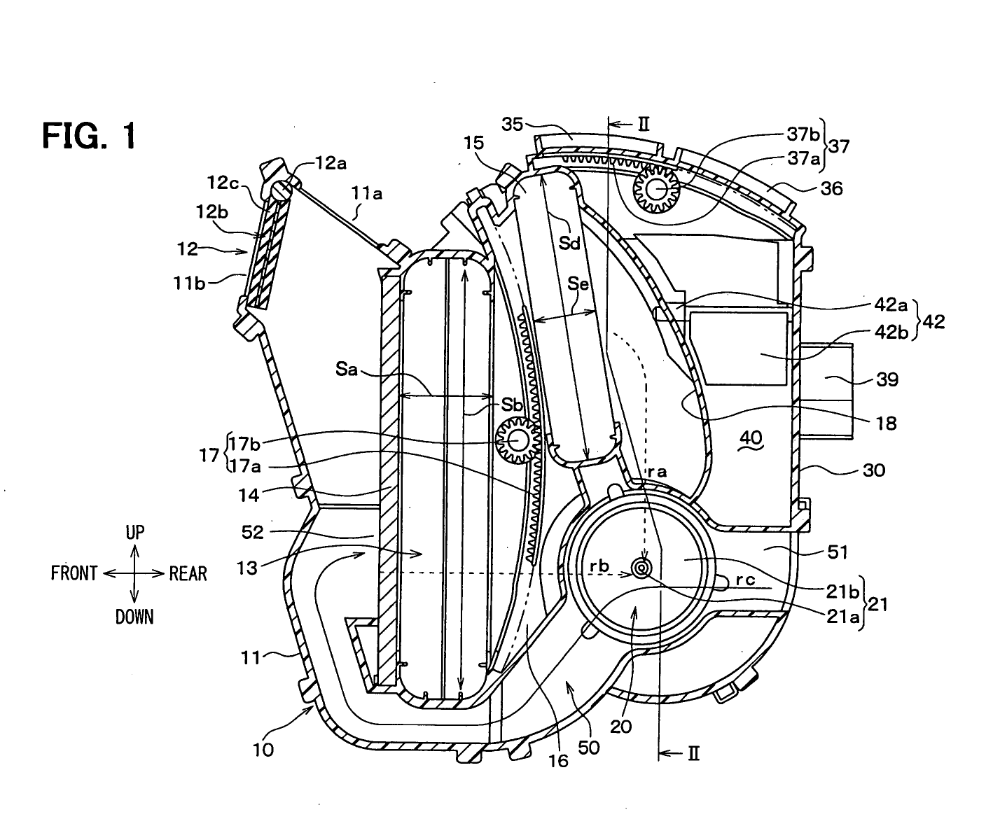

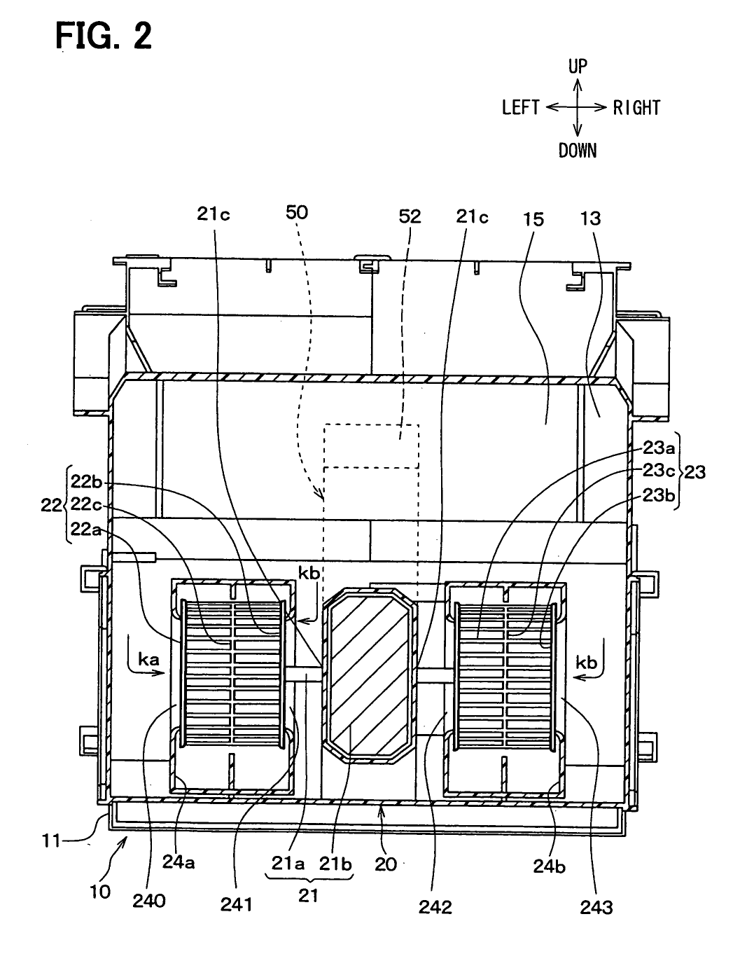

An air conditioning system according to a first embodiment of the present invention will be described with reference to FIGS. 1 and 2. FIG. 1 is a cross-sectional view of a room unit assembly 10 of the vehicular air conditioning system viewed in a vehicle left-right direction. FIG. 2 is a cross sectional view showing an inside of the room unit assembly 10 viewed in a direction indicated by an arrow II in FIG. 1 A group of arrows indicating an upward direction, a downward direction, a frontward direction, and a rearward direction in FIG. 1 corresponds to directions when the vehicular air conditioning system is mounted in a vehicle. Also, another group of arrows indicating an upward direction, a downward direction, a left direction, and a right direction in FIG. 2 corresponds to directions when the vehicular air conditioning system is mounted in the vehicle.

The room unit assembly 10 is provided within an instrument panel around a center section in a vehicle width direction (in other words, in a left-right direction of the vehicle). The above instrument panel is located at a front part of a room (or a passenger compartment). The room unit assembly 10 includes an air-conditioner casing 11, which serves as an outer shell of the room unit assembly 10, and which defines therein as an air passage for air blown to the room. The air-conditioner casing 11 has a certain elasticity and is made of a resin having a substantial strength. The above resin may be a polypropylene, for example.

Further, the air-conditioner casing 11 includes a divisional surface around a center section in the vehicle width direction (or around a center section of the air-conditioner casing 11 along a width axis of the air-conditioner casing 11), and the divisional surface extends in an up-down direction of the vehicle. The divisional surface divides the air-conditioner casing 11 into two transverse divided sections. Both of the above transverse divided sections are integrally joined with each other by using a faster (e.g., a metal spring, a clip, a screw) in a state, where the transverse divided sections receive the components, such as an air filter 14, an evaporator 13, a heater core 15.

As shown in FIG. 1, the air-conditioner casing 11 defines therein an air passage on a vehicle front side and a vehicle upper side of the air-conditioner casing 11. There are formed an internal air introduction port 11a and an external air introduction port 11b at a most upstream part of the air passage. The internal air introduction port 11a introduces internal air (internal air inside the room or inside the vehicle compartment) into the air-conditioner casing 11. The external air introduction port 11b introduces external air (external air outside the room or outside the vehicle compartment) into the air-conditioner casing 11.

Also, there is formed an internal-external air switching member 12 that is rotatably disposed inside the air passage for opening and closing the internal air introduction port 11a and the external air introduction port 11b such that the internal air and the external air is selectively introduced. Specifically, the internal-external air switching member 12 is a cantilever door that has a door main body portion 12c and a rotating shaft 12a fixed integrally with one end of the door main body portion 12c. The door main body portion 12c has a plate shape, and the rotating shaft 12a extends in the vehicle width direction.

The internal-external air switching member 12 rotates the rotating shaft 12a by using a servo motor (not shown). Thus, the internal-external air switching member 12 rotationally moves the door main body portion 12c such that opening areas of the internal air introduction port 11a and the external air introduction port 11b are continuously changed. The evaporator 13 is disposed downstream of the internal-external air switching member 12 in a direction of air flow.

The evaporator 13 is one of the components that constitute a known vapor-compression refrigeration cycle (not shown), and the evaporator 13 serves as a cooling heat exchanger that evaporates low-pressure refrigerant in the refrigeration cycle to cause an endoergic reaction to cool the air blown to the room.

The evaporator 13 includes multiple tubes, tanks, and heat exchanger fins and has a flat shape. The evaporator 13 is provided to extends in a vertical direction or in an up-down direction relative to the vehicle when the evaporator 13 is mounted on the vehicle. In other words, the evaporator 13 extends along a flat axis, and the flat axis corresponds to the vertical direction. In the present embodiment, the above flat axis is orthogonal to a thickness direction Sa of the evaporator 13 and is also orthogonal to the vehicle left-right direction. Thus, the flat axis of the evaporator 13 is indicated as a longitudinal axis Sb of the evaporator 13. That is, the flat axis of the evaporator 13 corresponds to the longitudinal axis Sb of a cross section of the evaporator 13, the cross section being taken along a plane perpendicular to the width axis of the air-conditioner casing 11. The upper portion and the lower portion of the evaporator 13 are supported by the air-conditioner casing 11.

Inside the air-conditioner casing 11, the air filter 14 having a thin plate shape is disposed upstream of the evaporator 13 in the air flow direction. The air filter 14 removes dust from air that flows into the evaporator 13 to clean the air.

The heater core 15 is disposed downstream of the evaporator 13 in the air flow direction. In other words, the heater core 15 is provided on a vehicle rear side and a vehicle upper side of the evaporator 13. The heater core 15 receives high-temperature engine coolant, which circulates in a engine coolant circuit (not shown), and which flows into the heater core 15 from the circuit. Thus, the heater core 15 serves as a heating heat exchanger, which exchanges heat between (a) the engine coolant and (b) the cold air cooled by the evaporator 13 to reheat the cold air.

The heater core 15 includes multiple tubes, upper and lower tanks, and heat exchanger fins to have a flat shape. The heater core 15 is tilted by a predetermined angle (less than about 30°) relative to the evaporator 13 such that the heater core 15 is aligned with or is provided generally in parallel with the evaporator 13.

In the above configuration, the heater core 15 has an upper portion that is positioned slightly toward a vehicle front side relative to a lower portion of the heater core 15. The upper and lower portions of the heater core 15 are supported by the air-conditioner casing 11.

Next, there is a bypass passage 16 provided on the vehicle rear side of the evaporator 13 and on a lower side of the heater core 15. The bypass passage 16 causes the cold air (cooled air), which has passed through the evaporator 13, to bypass the heater core 15. In other words, the bypass passage 16 allows the cold air to pass therethrough to bypass the heater core 15, for example.

Further, as shown in FIG. 1, there is provided an air-mixing door 17 immediately after or immediately downstream of the evaporator 13. The air-mixing door 17 serves as a temperature adjustment door that adjusts a rate (ratio) of (a) an amount of cold air that flows toward the heater core 15 to (b) an amount of cold air that flows toward the bypass passage 16. In other words, the air-mixing door 17 adjusts a ratio of (a) an amount of a first part of cold air, which part flows toward the heater core 15, to (b) an amount of a second part of cold air, which part flows toward the bypass passage 16, for example. The air-mixing door 17 includes a plate member 17a and a gear mechanism 17b. The plate member 17a is curved to have an arcuate cross sectional shape and extends in the vehicle up-down direction. The air-mixing door 17 serves as a slide door, in which a servo motor (not shown) displaces the plate member 17a in a curved direction via the gear mechanism 17b.

More specifically, by displacing (or sliding) the plate member 17a of the air-mixing door 17 in the upward direction of the vehicle, an opening degree of a passage connected to the bypass passage 16 is increased, and an opening degree of an other passage connected to the heater core 15 is decreased. In contrast, by displacing (or sliding) the plate member 17a in the downward direction of the vehicle, the opening degree of the passage to the bypass passage 16 is decreased, and the opening degree of the other passage to the heater core 15 is increased.

By adjusting the opening degrees of passages of the air-mixing door 17, the air amount rate of the cold air and the hot air suctioned into an air blower 20 is adjusted. Thus, a temperature of the air blown to the room by the air blower 20 is able to be adjusted. In other words, the air-mixing door 17 constitutes temperature adjusting means for adjusting the temperature of the air blown to the room.

The air blower 20 is provided on a lower side of the heater core 15 inside the air-conditioner casing 11 and is on an imaginary extension of the heater core 15. In the above description, a position on the imaginary extension of the heater core 15 means a position located on the lower side of the heater core 15 along a flat axis (an axis indicated by the arrow Sd in FIG. 1). In the above, the flat axis of the heater core 15 corresponds to a longitudinal axis Sd of a cross section of the heater core 15, which cross section is taken by a plane perpendicular to the width axis of the air-conditioner casing 11, for example.

Specifically, the air blower 20 includes an electric motor 21, impellers 22, 23, and scroll casings 24a, 24b as shown in FIG. 1 and FIG. 2. It should be noted that numeral 24a is shown in FIG. 1, and numeral 24b is shown in FIG. 2.

As shown in FIG. 2, the electric motor 21 is provided within the air-conditioner casing 11 around a center section in the vehicle left-right direction, and the electric motor 21 has a rotating shaft that extends in both directions along a left-right axis of the vehicle. The electric motor 21 is forcibly cooled by a cooling structure as described later.

Each of the impellers 22, 23 is a centrifugal multiblade fan, and the impeller 22 is fixed to a left end portion (projection end portion) of the rotating shaft of the electric motor 21. The impeller 22 includes a fan member 22a, a fan member 22b, and a partition wall 22c. The fan member 22a includes multiple blades arranged around the rotating shaft and suctions air from a left side of the fan member 22a along the rotating shaft or in a direction as indicated by an arrow ka in FIG. 2. Then, the fan member 22a blows air in the radial direction of the fan member 22a. Also, the fan member 22b includes multiple blades arranged around the rotating shaft and suctions air from a right side of the fan member 22b along the rotating shaft or in a direction as indicated by an arrow kb in FIG. 2. Then, the fan member 22b blows air in the radial direction of the fan member 22b (or of the rotating shaft). The partition wall 22c partitions the fan members 22a, 22b. As above, the impeller 22 is able to suction air from both ends of the impeller 22 along the rotating shaft and is able to blow air in the radial direction of the impeller 22 (or of the rotating shaft).

The impeller 23 is fixed to the right end portion of the rotating shaft of the electric motor 21 and the impeller 23 includes a fan member 23a, a fan member 23b, and a partition wall 23c similar to the impeller 22. The fan member 23a includes multiple blades arranged around the rotating shaft and suctions air from a left side of the fan member 23a along the rotating shaft. Then, the fan member 23a blows air in the radial direction of the fan member 23a. The fan member 23b includes multiple blades arranged around the rotating shaft and suctions air from a right side of the fan member 23b along the rotating shaft. Then, the fan member 23b blows air in the radial direction of the fan member 23b. The partition wall 23c partitions the fan members 23a, 23b. As above, the impeller 23 is able to suction air from both sides of the impeller 23 along the axis of the rotating shaft and is able to blow air in the radial direction of the impeller 23 (or of the rotating shaft).

The scroll casing 24a receives each of the fan members 22a, 22b of the impeller 22 and forms an outflow air passage, through which air flowing out of the fan members 22a, 22b flows. The scroll casing 24a defines an outflow air passage having a convoluted shape, and the outflow air passage has a cross sectional area that is gradually increased as a function of a position in a rotation direction of the impeller 22. The scroll casing 24a includes suction ports 240, 241 and an outlet port. The suction ports 240, 241 are provided on both ends of the scroll casing 24a along the rotating shaft, and the outlet port allows the air, which is blown by the impeller 22, to flow upward.

The scroll casing 24b receives each of the fan members 23a, 23b of the impeller 23 and forms an outflow air passage, through which air flowing out of the fan members 23a, 23b flows. The scroll casing 24b defines an outflow air passage having a convoluted shape, and the outflow air passage has a cross sectional area that is increased as a function of a position in a rotation direction of the impeller 23. The scroll casing 24b includes suction ports 242, 243 and an outlet port. The suction ports 242, 243 are provided on both ends of the scroll casing 24b along the rotating shaft, and the outlet port allows the air, which is blown by the impeller 23, to flow upward.

There is provided a partition wall 18 within the air-conditioner casing 11 on a vehicle rear side of the heater core 15, and the partition wall 18 serves as a guide wall that guides hot air (heated air), which flows from or has passed through the heater core 15, toward the air blower 20 as shown in FIG. 1.

There is provided an air passage 40 (see FIG. 1) inside the air-conditioner casing 11 between the partition wall 18 and a rear wall 30 for guiding the air blown by the scroll casings 24a, 24b toward outlet ports 35, 36. The outlet port 36 is provided on a vehicle rear side portion of an upper surface portion of the air-conditioner casing 11, and the outlet port 36 is a face opening portion, which causes air flowing in the air passage 40 to flow toward an upper body of an occupant.

The outlet port 35 is located on the upper surface portion of the air-conditioner casing 11 at a position on a vehicle front side of the outlet port 36. The outlet port 35 serves as a defroster opening portion, which causes air flowing in the air passage 40 to flow toward an inner face of the windshield of the vehicle. There is provided a blow mode door 37 at a position inward of the outlet ports 35, 36 in the air-conditioner casing 11. The blow mode door 37 includes a plate member 37a and a gear mechanism 37b. The plate member 37a is curved to have an arcuate cross sectional shape and extends in a vehicle fore-and-aft direction. The blow mode door 37 serves as a slide door, in which a servo motor (not shown) displaces the plate member 37a in a curved direction via the gear mechanism 37b.

More specifically, by displacing or sliding the plate member 37a of the blow mode door 37 toward the front side of the vehicle, an opening degree of a passage connected to the outlet port 36 is increased, and an opening degree of an other passage connected to the outlet port 35 is decreased. In contrast, by displacing or sliding the plate member 37a toward the vehicle rear side, the opening degree of the passage to the outlet port 35 is increased, and the opening degree of the other passage to the outlet port 36 is decreased.

There is provided a rear seat foot opening portion 39 to the rear wall 30 of the air-conditioner casing 11 as shown in FIG. 1, and the rear seat foot opening portion 39 causes air flowing the air passage 40 to flow toward feet of an occupant in a rear seat. The air-conditioner casing 11 includes a front seat foot opening portion (not shown), and the front seat foot opening portion causes air flowing in the air passage 40 to flow toward feet of an occupant in a front seat.

In the air-conditioner casing 11, there is provided a foot door 42 on an inner side of both of the above foot opening portions. The foot door 42 is a butterfly door that includes a rotating shaft 42a and a door main body portion 42b. The rotating shaft 42a is integral with the door main body portion 42b and is fixed to a generally center section of the door main body portion 42b. The rotating shaft 42a extends in the vehicle fore-and-aft direction. The door main body portion 42b has a plate shape. The rotating shaft 42a is rotated by a servo motor (not shown) for rotationally displacing the door main body portion 42b such that the above foot opening portions are opened and closed.

Next, the cooling structure of the present embodiment will be described with reference to FIGS. 1 to 3.

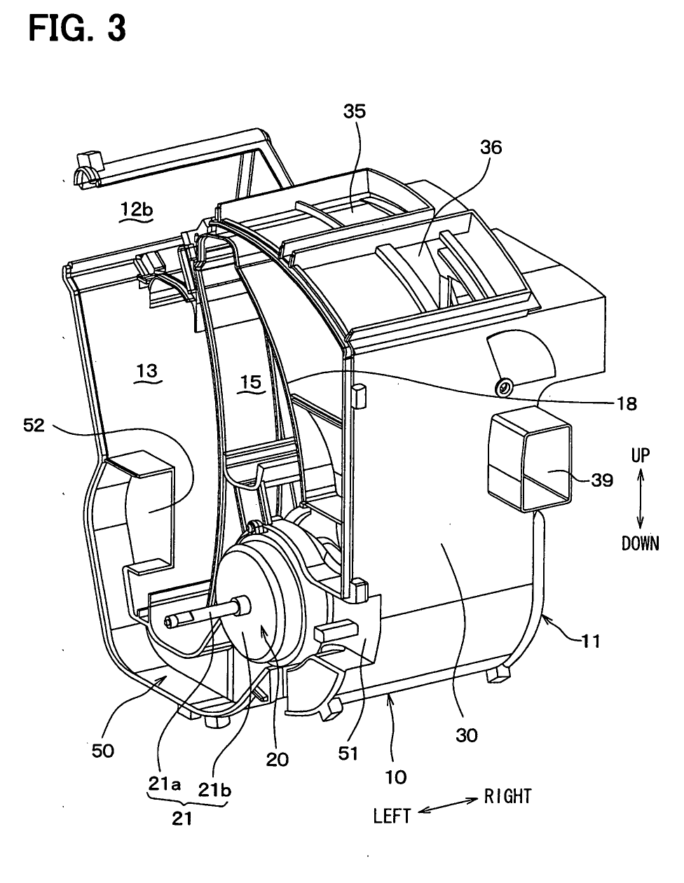

FIG. 3 is a cross-sectional perspective view of the inside of the room unit assembly 10 viewed from the vehicle left-right direction. In FIG. 3, in order to specifically show the cooling structure for cooling the electric motor 21, shapes of the evaporator 13 and the heater core 15 are not outlined but are indicated by numerals 13 and 15.

The room unit assembly 10 includes a cooling passage 50 (air passage). The cooling passage 50 includes an inlet port 51 and a discharge port 52. The inlet port 51 opens to the room or the passenger compartment, and the discharge port 52 opens in the air-conditioner casing 11 to a position or to a space upstream of the air filter 14 in the flow direction of air. In other words, the discharge port 52 opens to a position upstream of the evaporator 13 in the flow direction of air. The inlet port 51 is formed at the rear wall 30 of the air-conditioner casing 11.

The cooling passage 50 provides communication between the inlet port 51 and the discharge port 52, and covers a motor main body 21b of the electric motor 21. Thus, the motor main body 21b of the electric motor 21 is exposed to the room or the passenger compartment, which is outside of the air-conditioner casing 11. In other words, the motor main body 21b of the electric motor 21 is provided in the cooling passage 50 and is exposed to the room via the inlet port 51.

The cooling passage 50, as shown in FIGS. 1 and 3, is configured to extend from the inlet port 51 to the discharge port 52 via a space below the evaporator 13. Thus, as shown in FIG. 1, the cooling passage 50 has an L-shaped cross section. The motor main body 21b rotatably supports the rotating shaft 21a, and rotates the rotating shaft 21a by an electromagnetic force. The cooling passage 50 is provided with two through holes 21c, and the rotating shaft 21a of the electric motor 21 extends through the holes 21c.

Next, an operation of the room unit assembly 10 of the present embodiment will be described.

Firstly, the electric motor 21 of the air blower 20 rotates each of the impellers 22, 23. Then, the impeller 22 suctions air through suction ports 240, 241 of the scroll casing 24a and blows air through the outlet port of the scroll casing 24a. The impeller 23 suctions air through suction ports 242, 243 of the scroll casing 24b and blow air through the outlet port of the scroll casing 24b. By the above operation of the air blower 20, air is introduced into the air-conditioner casing 11 via at least one of the internal-air introduction port 11a and the external-air introduction port 11b. The air introduced through the at least one port flows into the evaporator 13 via the air filter 14.

By an operation of the air blower 20, internal air (air in the room) is introduced into the cooling passage 50 through the inlet port 51, and room air (air in the room) is caused to flow from the inlet port 51 toward the discharge port 52 via the cooling passage 50 in a direction as indicated by an arrow rc.

In the above configuration and operation, the electric motor 21 generates heat from the motor main body 21b when the electric motor 21 rotates the impellers 22, 23. However, the motor main body 21b is cooled by room air that passes through the cooling passage 50.

Also, room air, which has cooled the motor main body 21b, flows through the discharge port 52 toward a space or a position upstream of the air filter 14 in the flow direction of air. Then, the room air flows through the air filter 14 to flow into the evaporator 13.

As above, (a) room air, which has passed through the cooling passage 50, and (b) introduced air, which is introduced through at least one of the internal-air introduction port 11a and the external-air introduction port 11b, are cooled to be cold air via heat exchange with refrigerant when (a) the room air and (b) the introduced air pass through the evaporator 13.

Here, when the air-mixing door 17 opens each of the passage entry to the bypass passage 16 and the passage entry to the heater core 15, part of cold air, which flows from or is cooled by the evaporator 13, flows into the heater core 15 and is heated by the heater core 15. As a result, the part of cold air flows out of the heater core 15 as hot air. The hot air is guided by the partition wall 18 toward the air blower 20 and flows in a direction indicated by an arrow ra in FIG. 1. Rest of cold air, which flows from or is cooled by the evaporator 13, flows through the bypass passage 16 and flows in a direction indicated by an arrow rb in FIG. 1.

As a result, the cold air, which has passed through the bypass passage 16, and the hot air, which flows from the heater core 15, flow toward both suction ports of the scroll casing 24a. Before being suctioned through the above suction ports, the cold air and the hot air collide with each other by an angle of about 90°. Also, the cold air, which has passed through the bypass passage 16, and the hot air, which flows out of the heater core 15, flows toward both of the suction ports of the scroll casing 24b. Before being suctioned through the above suction ports, the cold air and the hot air collide with each other by an angle of about 90°.

As above, the cold air and the hot air, which collide with each other before being suctioned into the scroll casings 24a, 24b, are suctioned by the operation of the impellers 22, 23 and are blown in the radial direction of the impellers 22, 23. As a result, the cold air and the hot air of interest are mixed with each other and are blown in the radial direction as air for air conditioning.

The air for air conditioning passes through the scroll casings 24a, 24b and is blown to the air passage 40. The blown air for air conditioning passes through the air passage 40 and is blown into the room through one of the outlet ports 35, 36, the rear seat foot opening portions 39, and the front seat foot opening portions (not shown).

In the above present embodiment, the motor main body 21b of the electric motor 21 of the air blower 20 is provided outside the air-conditioner casing 11. Specifically, the cooling passage 50 is provided for communicating between (a) the room or the passenger compartment, which is outside the air-conditioner casing 11, and (b) the position upstream of the air filter 14 in the air-conditioner casing 11. The motor main body 21b of the electric motor 21 is provided inside the cooling passage 50. Thus, when the air blower 20 is in operation, air flows from the inlet port 51 toward the position upstream of the air filter 14 via the cooling passage 50. The above happens because of the followings. When the air blower is operated, the pressure of air in the air-conditioner casing 11 at a position close to the discharge port 53 located upstream of the air filter 14 becomes lower relative to the pressure of air outside the air-conditioner casing 11. In other words, the pressure in the space or in the air-conditioner casing 11 at a position close to the discharge port 53 becomes negative pressure when the air blower 20 is operated, and thereby the air in the room and in the cooling passage 50 is caused to flow through the cooling passage 50 to flow into the air-conditioner casing 11. As a result, the motor main body 21b is forcibly cooled by room air that flows through the cooling passage 50. Accordingly, even when the temperature of air that is blown into the room through the outlet ports 35, 36 is relatively high being caused by adjusting the opening of the air-mixing door 17, the motor main body 21b is able to be cooled substantially.

In the present embodiment, room air, which has passed through the cooling passage 50, is blown to the position upstream of the air filter 14. As a result, even when room air, which has passed through the cooling passage 50, has dust therein, the dust is removed from the air and the room air is purified or cleaned.

In the present embodiment as described above, the air blower 20 is provided on the lower side of the heater core 15 on an extension of the heater core 15. In other words, the air blower 20 is provided on a lower side of the heater core 15 along the flat axis Sd of the heater core 15. Thus, cold air, which has passed through the bypass passage 16, and hot air, which flows from the heater core 15, collide with each other by an angle of about 90° before the cold air and the hot air are suctioned into the suction ports of the scroll casing 24a (24b). In other words, the cold air, which has passed through the bypass passage 16, collides with the hot air, which has passed through the heating heat exchanger 15, by a degree of about 90° at a position upstream of the suction ports of the scroll casing 24a (24b) of the impeller 22, 23 of the air blower 20 in the flow direction of air, for example.

Thus, the cold air and the hot air are suctioned into the air blower 20 after the cold air has collided with the hot air as above. As a result, the cold air is effectively mixed with the hot air by the impellers 22, 23 of the air blower 20, and thereby air for air conditioning, which is blown into the room through the outlet ports 35, 36 and the foot opening portions 39, 41, is limited from having a biased distribution of the temperature.

In the present embodiment, the evaporator 13 and the heater core 15 are arranged generally in parallel with each other. Thus, the room unit assembly 10 is reduced in size.

In the present embodiment, the partition wall 18 guides hot air, which flows from the heater core 15, toward both of the suction ports of the scroll casing 24a (24b) of the air blower 20 within the air-conditioner casing 11. Thus, cold air is made more reliably collide with hot air.

In the present embodiment, the electric motor 21 is provided at the center section inside the air-conditioner casing 11 in the vehicle left-right direction. Also, the impeller 22 is provided on a left end (one projection end) of the rotating shaft of the electric motor 21, and the impeller 23 is provided on a right side (the other projection end) of the rotating shaft of the electric motor 21.

Thus, an air flow is limited from having biased wind velocity distribution in the vehicle left-right direction of the air-conditioner casing 11 (along the axis of the rotating shaft). Accordingly, the wind velocity distribution of air, which passes through the evaporator 13, is limited from being biased, and the wind velocity distribution of air, which passes through the heater core 15, is also limited from being biased. Thus, mixing of hot air with cold air is reliably performed.

Also, because each of the impellers 22, 23 suctions air from both ends thereof along the rotational axis of the impellers 22, 23, the wind velocity distribution of air flow in the vehicle left-right direction of the air-conditioner casing 11 is further limited from being biased. Thus, the wind velocity distribution of air, which passes through the evaporator 13, is further limited from being biased, and the wind velocity distribution of air, which passes through the heater core 15, is further limited from being biased. Therefore, mixing of hot air with cold air is further effectively and more reliably performed.

In the above first embodiment, cold air, which has passed through the bypass passage 16, and hot air, which flows from the heater core 15, collide with each other by an angle of about 90° before the cold air and the hot air are suctioned into the suction ports of the scroll casing 24a (24b). However, the embodiment is not limited to the above. For example, cold air, which has passed through the bypass passage 16, and hot air, which flows from the heater core 15, may alternatively collide with each other by an angle of about 70° to 110°.

### Second Embodiment

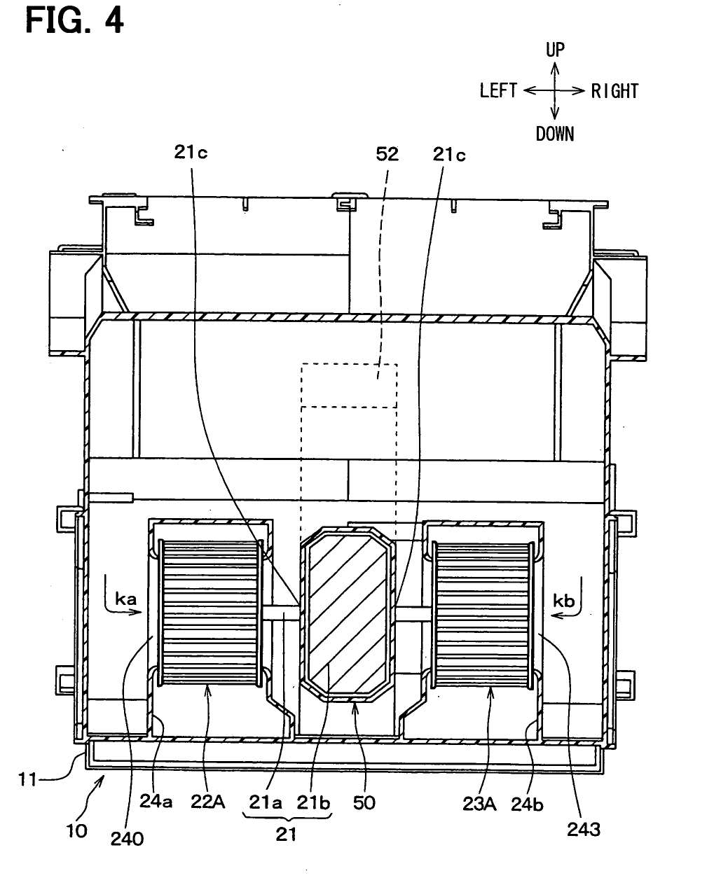

In the above first embodiment, the impeller 22 (23) of the air blower 20 suctions air from both ends thereof along the rotational axis of the impeller 22 (23) or along the axis of the rotating shaft. In contrast, an impeller 22A (23A) of an air blower 20 of the second embodiment suctions air from only one end of the impeller along the rotational axis as shown in FIG. 4. Similar components of an air conditioning system in FIG. 4, which are similar to the components of the air conditioning system in FIGS. 1 to 3, will be indicated by the same numerals.

Specifically, the impeller 22A suctions air from a left side of the impeller 22A along the rotational axis of the impeller 22A as indicated by an arrow ka, and blows air in the radial direction of the impeller 22A. The impeller 23A suctions air from a right side of the impeller 23A along the rotational axis in a direction as indicated by an arrow kb, and blows air in the radial direction of the impeller 23A. The impeller 22A is housed by the scroll casing 24a, and the impeller 23A is housed by the scroll casing 24b. A numeral 21a in FIG. 3 indicates the rotating shaft.

Similar to the above first embodiment, the cooling passage 50 of the second embodiment includes the inlet port 51 (not shown), which opens to the room (passenger compartment), and the discharge port 52, which opens within the air-conditioner casing 11 upstream of the air filter 14 in the air flow direction. The cooling passage 50 provides communication between the inlet port 51 and the discharge port 52 and covers the motor main body 21 b of the electric motor 21. It should be noted that in the present embodiment, a structure of the air blower 20 other than the impeller 22 (23) is similar to the structure shown in the above first embodiment, and thereby the explanation thereof is omitted.

### Third Embodiment

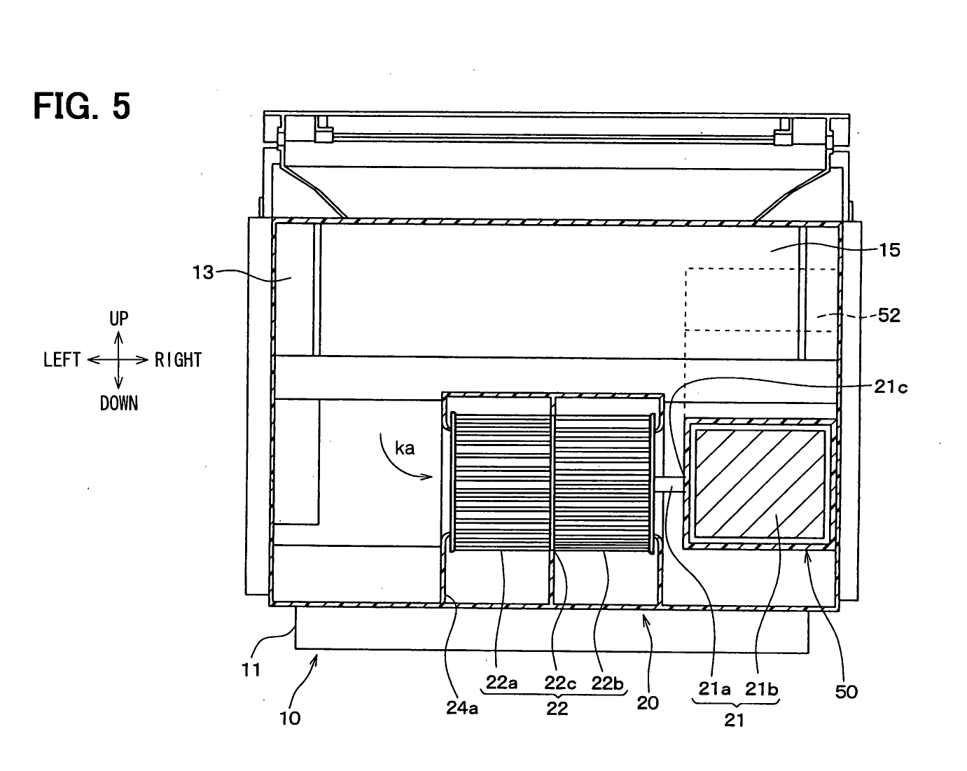

In the above first embodiment, the air blower 20 has two impellers 22, 23. In contrast, an air blower 20 of the third embodiment employs only one impeller 22 as shown in FIG. 5. Similar components of an air conditioning system in FIG. 5, which are similar to the components of the air conditioning system in FIGS. 1, 2, will be indicated by the same numerals, and thereby explanation thereof is omitted.

In the third embodiment, the electric motor 21 (in other words, the motor main body 21b) is provided toward a vehicle right side (in other words, on one side) or is positioned off-center from the center axis of the air-conditioner casing 11, and the rotating shaft 21a of the electric motor 21 projects toward a vehicle left side (in other words, another side). As above, the single impeller 22 is provided at center section in the vehicle left-right direction. In other words, the single impeller 22 is provided around a center of the air-conditioner casing 11 along the width axis of air-conditioner casing 11.

The impeller 22 is fixed to an left end side of the rotating shaft 21a of the electric motor 21, and the impeller 22 includes a fan member 22a, a fan member 22b, and a partition wall 22c similar to the above first embodiment. The fan member 22a suctions air from a left side of the fan member 22a along the rotational axis, about which the fan member 22a rotates, in a direction as indicated by an arrow ka in the drawing. Then, the fan member 22a blows air in the radial direction. Also, the fan member 22b includes multiple blades arranged around the rotating shaft and suctions air from a right side of the fan member 22b along the rotating shaft. Then, the fan member 22b blows air in the radial direction of the fan member 22b (or of the rotating shaft). The partition wall 22c partitions the fan members 22a, 22b. As above, the impeller 22 is able to suction air from both sides of the impeller 22 along the rotating shaft and is able to blow air in the radial direction of the impeller 22 (or of the rotating shaft).

The cooling passage 50 of the third embodiment has a structure similar to the cooling passage 50 of the first embodiment. However, the cooling passage 50 of the third embodiment is provided toward a vehicle right side to correspond to a position of the electric motor 21.

In the above third embodiment, the electric motor 21 is provided toward the vehicle right side in the air-conditioner casing 11 to be positioned off-center from the central axis of the air-conditioner casing 11, and the rotating shaft 21 a of the electric motor 21 projects toward the vehicle left side. However, alternatively, the electric motor 21 may be provided on a vehicle left side of the central axis of the air-conditioner casing 11, and the rotating shaft 21a of the electric motor 21 may projects toward the vehicle right side.

### Fourth Embodiment

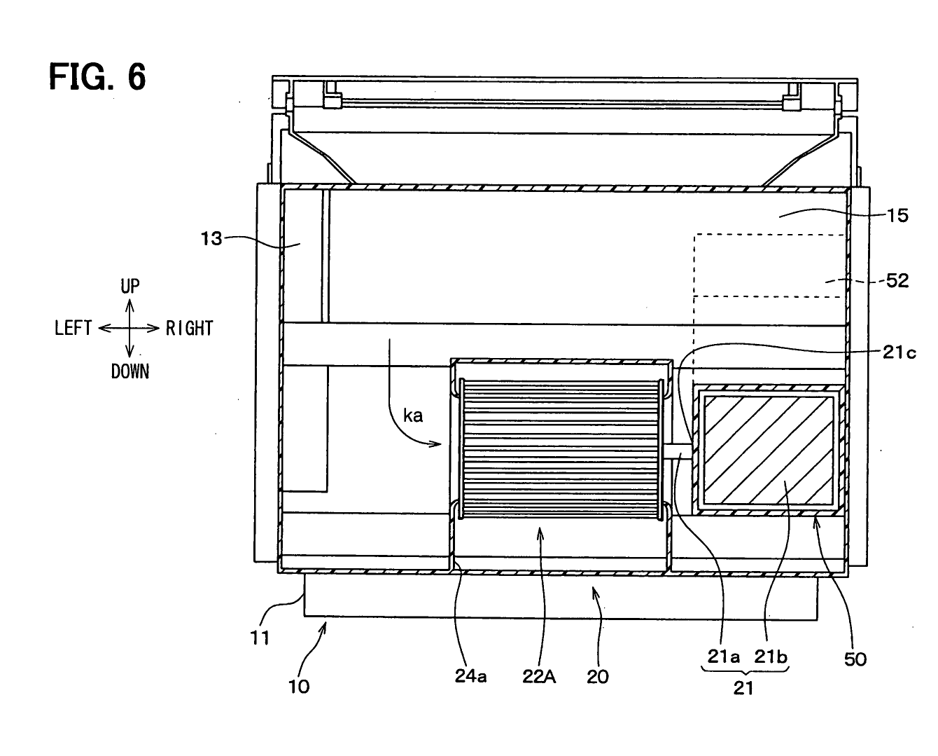

In the above third embodiment, the air blower 20 employs a certain impeller as the impeller 22, which suctions air from both sides of the impeller 22 along the rotational axis, and which blows air in the radial direction of the impeller 22. However, it is not limited to the above. In the fourth embodiment, as shown in FIG. 6, another impeller is used as the impeller 22A and the centrifugal fan suctions air from one side of the centrifugal fan along the rotational axis and blows air in the radial direction of the centrifugal fan. Similar components of an air conditioning system in FIG. 6, which are similar to the components of the air conditioning system in FIG. 5, will be indicated by the same numerals, and thereby explanation thereof is omitted. In the fourth embodiment, a similar cooling passage 50 is provided similar to the above third embodiment.

### Fifth Embodiment

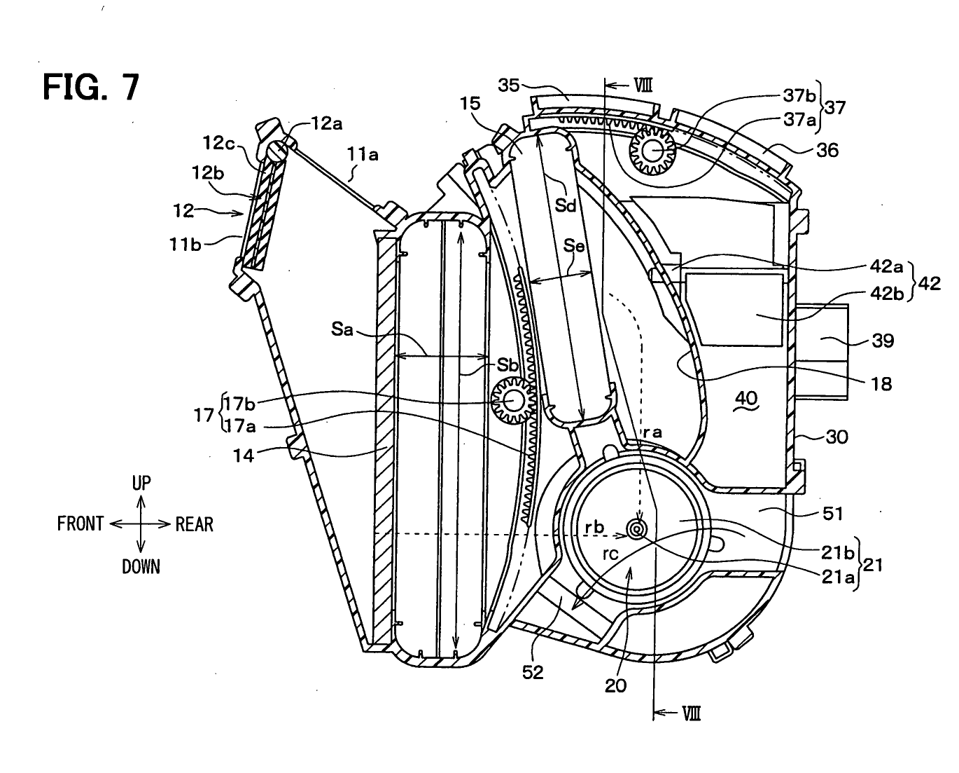

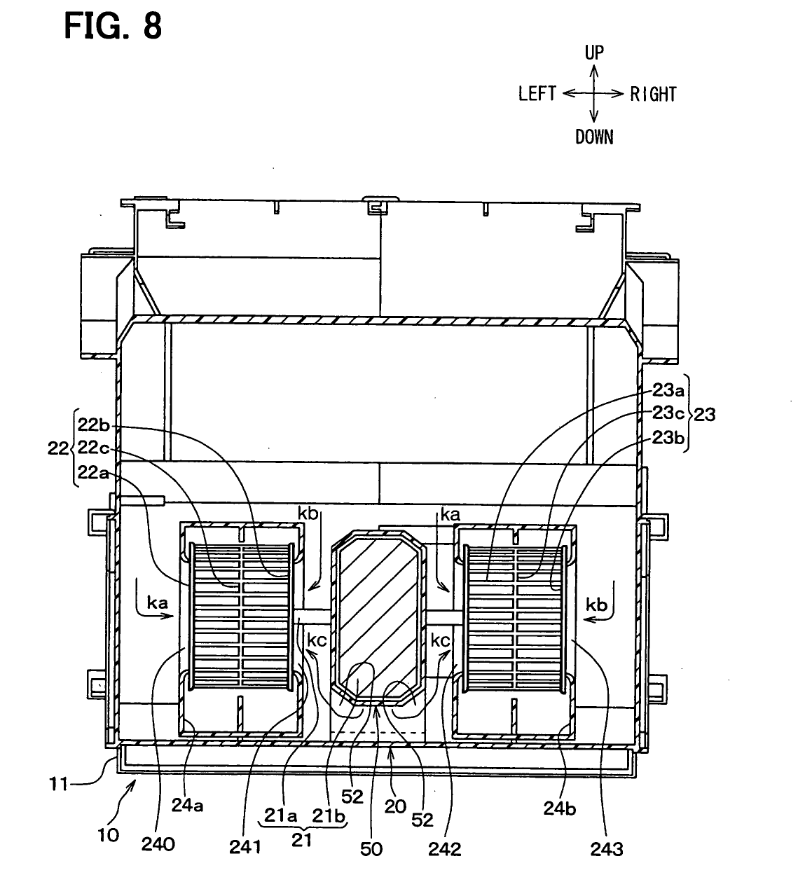

In the above first embodiment, the discharge port 52 of the cooling passage 50 open upstream of the air filter 14. However, alternatively, in the fifth embodiment, as shown in FIGS. 7, 8, the discharge port 52 of the cooling passage 50 may be provided downstream of the air-mixing door 17 and upstream of the air blower 20 in the air flow direction. FIG. 7 is a cross-sectional view of the room unit assembly 10 viewed from in the vehicle left-right direction, and FIG. 8 is a cross-sectional view taken along line VIII-VIII in FIG. 7.

Specifically, the cooling passage 50 is provided with two discharge ports 52, and one of the discharge ports 52 opens toward the vehicle left side at a position close to the inlet port 241 of the scroll casing 24a. The other one of the discharge ports 52 open toward the vehicle right side at a position close to the inlet port 242 of the scroll casing 24b. Similar components of an air conditioning system in FIGS. 7 and 8, which are similar to the components of the air conditioning system in FIGS. 1 to 3, will be indicated by the same numerals, and thereby explanation thereof is omitted.

In the fifth embodiment, the operation of the air blower 20 causes internal air (air in the room) blown into the cooling passage 50 via the inlet port 51 in a direction as indicated by an arrow rc in FIG. 7, and after the internal air (air flow) cools the motor main body 21b, the internal air is caused to flow into the air-conditioner casing 11 through the two discharge ports 52. Internal air that flows through the left discharge port 52 is suctioned through the inlet port 241 of the scroll casing 24a in a direction indicated by an arrow kc in FIG. 8. Internal air that flows through the right discharge port 52 is suctioned through the inlet port 242 of the scroll casing 24b in a direction indicated by another arrow kc in FIG. 8.

The scroll casings 24a, 24b also suction (a) cold air, which has passed through the bypass passage 16, and (b) hot air, which has passed through the heater core 15. Accordingly, (a) the cold air, (b) the hot air, and (c) the internal air, which has cooled the motor main body 21b, are blown to the air passage 40 through the scroll casings 24a, 24b in accordance with the rotation of the impellers 22, 23. The air for air conditioning passes through the air passage 40 and is blown to the room (passenger compartment) via any one of the outlet ports 35, 36 and the foot opening portions.

In the above fifth embodiment, similar to the above first embodiment, the motor main body 21b is provided in the cooling passage 50 that is positioned outside the air-conditioner casing 11, and the operation of the air blower 20 causes flow of room air in the cooling passage 50. Thus, the room airflow cools the motor main body 21b of the electric motor 21. Accordingly, even when the temperature of air blown to the room through the outlet ports 35, 36 is relatively high, the motor main body 21b is able to be cooled substantially.

### Other Embodiment

In the above first embodiment, the discharge port 52 of the cooling passage 50 is provided upstream of the air filter 14 in the air flow direction. However, it is not limited to the above. Alternatively, the discharge port 52 of the cooling passage 50 may be provided between the air filter 14 and the evaporator 13. Also, the discharge port 52 of the cooling passage 50 may be provided between the air-mixing door 17 and the evaporator 13.

In the above first to fifth embodiments, air-mixing type temperature adjusting means that employs the air-mixing door 17 is described. However, it is not limited to the above. Alternatively, reheat type temperature adjusting means may be used. In the reheat type temperature adjusting means, a flow of an engine coolant that circulates in the heater core 15 is adjusted such that heat quantity that transfers from the engine coolant to cold air is adjusted. As a result, the temperature of air blown through the outlet ports 35, 36 and the like is adjusted. In the above case, the evaporator 13 may be provided downstream of the heater core 15 in the flow direction of air.

In the above first to fifth embodiments, the air conditioning system is applied to the vehicular air conditioning system. However, it is not limited to the above. The above air conditioning system may be applied to other air conditioning system, which is installed on site, other than the vehicular air conditioning system.

According to the above first to fifth embodiments, the motor main body 21b is provided in the cooling passage 50 that is positioned outside the air-conditioner casing 11, and room air that flows through the cooling passage 50 cools the motor main body 21b of the electric motor 21. However, it is not limited to the above. Any structure may be employed provided that the motor main body 21b may be provided outside the air-conditioner casing 11 such that the motor main body 21b is cooled by room air.

In the above first to fifth embodiments, the flat axis of the heater core 15 corresponds to the longitudinal axis Sd that is orthogonal to the thickness direction Se and is also orthogonal to the vehicle left-right direction. In other words, the flat axis is orthogonal to a flow direction of air flowing through the heater core 15 and orthogonal to the width axis of the air-conditioner casing 11, for example. However, the flat axis of the heater core 15 may be alternatively the vehicle left-right direction that is orthogonal to the thickness direction Se. In the above alternative case, the air blower 20 may be provided on a side of the heater core 15 in the vehicle left-right direction.

In the above first to fifth embodiments, the air-mixing door 17 employs a slide door. However, it is not limited to the above. The air-mixing door 17 may be a plate door, or a rotary door.

In the above first to fifth embodiments, a centrifugal multiblade fan is employed as the impeller 22, 23(22A, 23A). However, it is not limited to the above. An axial fan may be used, alternatively.

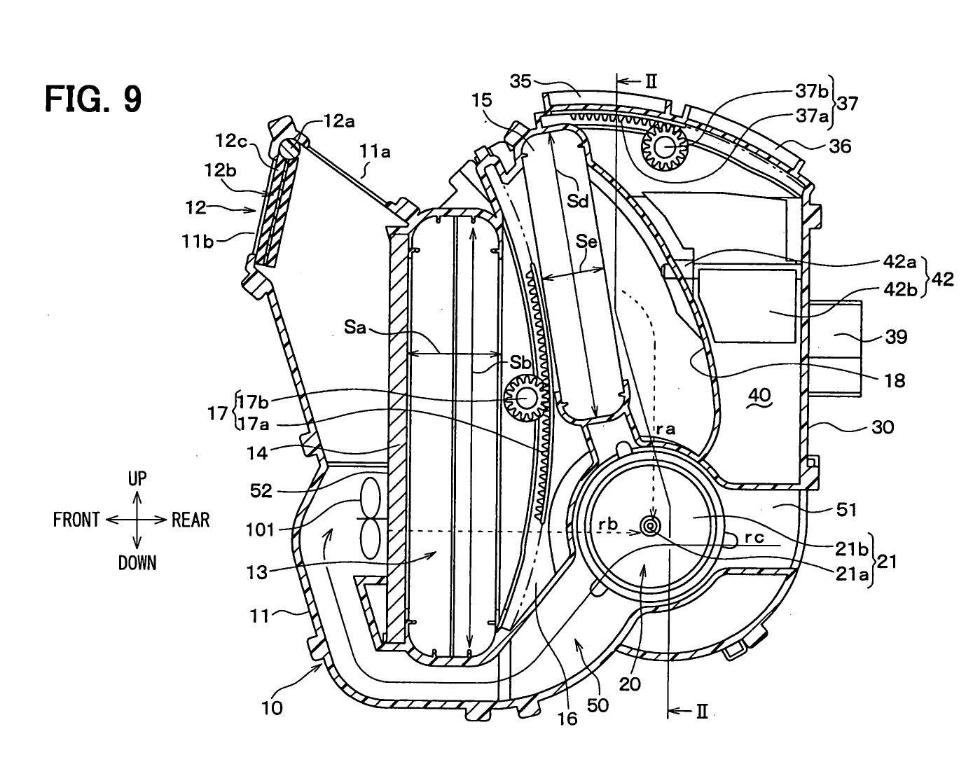

In the above first to fifth embodiments, for example, a cooling passage air blower 101 (air passage air blower) may be provided as shown in FIG. 9 at a specific position. The cooling passage air blower 101 serves as a dedicated blower that causes air to flow through the cooling passage 50. For example, the above specific position may be a position close to the inlet port 51 of the cooling passage 50, a position in the cooling passage 50 between (a) the inlet port 51 and (b) the discharge port 52, and a position close to the discharge port 52 of the cooling passage 50. As a result, air is forced to flow through the cooling passage 50.

In the above embodiments, the discharge port 52, is located upstream of the evaporator 13 in the flow direction of air.

Thus, although the room air in the air passage 50 is heated when the electric motor 20 is cooled, the heated room air is cooled again by the evaporator 13 because heated room air flows to the position upstream of the evaporator 13 in the flow direction of air. Thus, the room air, which has cooled the electric motor 20, will not cause adverse influence in air conditioning of the room.

Additional advantages and modifications will readily occur to those skilled in the art. The invention in its broader terms is therefore not limited to the specific details, representative apparatus, and illustrative examples shown and described.

What is claimed is:

1. An air conditioning system for conditioning air in a room, the air conditioning system comprising:
an air-conditioner casing that causes air to flow toward the room;
an air blower that includes an electric motor and an impeller, which is rotated by the electric motor to generate air flowing toward the room;
a cooling heat exchanger that is provided in the air-conditioner casing for cooling air; and
a heating heat exchanger that is provided in the air-conditioner casing for heating air, wherein:
the air blower is provided downstream of the cooling heat exchanger and the heating heat exchanger in a flow direction of air;
air in the room is conditioned based on cold air cooled by the cooling heat exchanger and hot air heated by the heating heat exchanger; and
the electric motor is provided outside the air-conditioner casing and is cooled by room air.

2. The air conditioning system according to claim 1, further comprising:
an air passage that is configured to cover the electric motor, the air passage including an inlet port and a discharge port, the inlet port opening to the room, the discharge port opening to a position upstream of the air blower in the flow direction of air within the air-conditioner casing, the air passage providing communication between the inlet port and the discharge port, wherein:
when the air blower blows air, pressure in a space close to the discharge port becomes negative, and thereby the room air in the air passage is forcibly caused to flow in a direction from the inlet port toward the discharge port.

3. The air conditioning system according to claim 2, wherein:
the discharge port is provided upstream of the cooling heat exchanger in the flow direction of air.

4. The air conditioning system according to claim 2, further comprising:
an air filter that is provided in the air-conditioner casing upstream of the cooling heat exchanger in the flow direction of air for purifying air, wherein:
the discharge port is provided upstream of the air filter in the flow direction of air.

5. The air conditioning system according to claim 2, wherein:
the discharge port is provided downstream of the cooling heat exchanger in the flow direction of air.

6. The air conditioning system according to claim 2, further comprising:
temperature adjusting means for adjusting a temperature of air that flows toward the room based on cold air cooled by the cooling heat exchanger and hot air heated by the heating heat exchanger.

7. The air conditioning system according to claim 6, wherein:
the heating heat exchanger heats cold air that is cooled by the cooling heat exchanger, the air conditioning system further comprising:
a cold air bypass passage that is provided in the air-conditioner casing for causing cold air that is cooled by the cooling heat exchanger to bypass the heating heat exchanger, wherein:
the temperature adjusting means adjusts a ratio of (a) an amount of air that flows toward the cold air bypass passage and (b) an amount of air that flows toward the heating heat exchanger such that a temperature of air that flows toward the room is adjusted.

8. The air conditioning system according to claim 7, wherein:
the discharge port is provided downstream of the temperature adjusting means in the flow direction of air.

9. The air conditioning system according to claim 1, wherein:
each of the heating heat exchanger and the cooling heat exchanger has a flat shape; and
the heating heat exchanger and the cooling heat exchanger are arranged generally in parallel with each other.

10. The air conditioning system according to claim 9, wherein:
the air blower is provided on an imaginary extension of the heating heat exchanger;
the electric motor includes a rotating shaft is provided generally in parallel with the heating heat exchanger; and
the impeller suctions air in a direction along an axis of the rotating shaft of the electric motor to blow air in a radial direction of the impeller.

11. The air conditioning system according to claim 10, wherein:
the cooling heat exchanger and the heating heat exchanger are arranged in parallel with a width axis of the air-conditioner casing;
the electric motor is provided at a center section in the air-conditioner casing along the width axis of the air-conditioner casing;
the rotating shaft of the electric motor projects in both directions along the width axis of the air-conditioner casing; and
the impeller is a first impeller that is provided at one projection end of the rotating shaft, the air blower further including a second impeller that is provided at an other projection end of the rotating shaft, the other projection end being opposite to the one projection end along the width axis.

12. The air conditioning system according to claim 11, wherein:
each of the first and second impellers suctions air from only one side of the each of the first and second impellers along the axis of the rotating shaft.

13. The air conditioning system according to claim 11, wherein:
each of the first and second impellers suctions air from both sides of the each of the first and second impellers along the axis of the rotating shaft.

14. The air conditioning system according to claim 10, wherein:
the cooling heat exchanger and the heating heat exchanger are arranged in parallel with a width axis of the air-conditioner casing;
the electric motor is positioned off-center from a width center of the air-conditioner casing toward one side in the air-conditioner casing along the width axis of the air-conditioner casing;
the rotating shaft of the electric motor is provided to project toward an other side in the air-conditioner casing along the width axis of the air-conditioner casing, the other side opposite to the one side along the width axis; and
the impeller is provided at one projection end of the rotating shaft, the one projection end projecting toward the other side in the air-conditioner casing.

15. The air conditioning system according to claim 14, wherein:
the impeller suctions air from only one side of the impeller along the axis of the rotating shaft.

16. The air conditioning system according to claim 14, wherein:
the impeller suctions air from both sides of the impeller along the rotating shaft.

17. The air conditioning system according to claim 1, further comprising:
a guide wall that is provided in the air-conditioner casing for guiding air, which has passed through the heating heat exchanger, toward the air blower.

18. The air conditioning system according to claim 2, further comprising:
an air passage air blower that is provided at one of following positions:
a position close to the inlet port of the air passage;
a position in the air passage between the inlet port and the discharge port; and
a position close to the discharge port of the air passage, wherein:
the air passage air blower causes air to flow through the air passage.

19. The air conditioning system according to claim 18, wherein:
the air passage air blower forces air to flow through the air passage.

20. The air conditioning system according to claim 1, further comprising:
an air passage that is provided outside the air-conditioner casing, the air passage including an inlet port and a discharge port at both ends of the air passage, the inlet port opening to the room, the discharge port opening to a position upstream of the air blower in the flow direction of air within the air-conditioner casing, wherein:
the electric motor of the air blower is provided inside the air passage; and
air in the room is suctioned into the air-conditioner casing via the air passage when the air blower blows air toward the room.

21. The air conditioning system according to claim 1, further comprising:
a passage casing that is provided outside the air-conditioner casing, the passage casing defining an air passage that includes an inlet port and a discharge port at both ends of the air passage, the inlet port opening to the room, the discharge port opening to a position upstream of the air blower in the flow direction of air within the air-conditioner casing, wherein:
the electric motor of the air blower is provided inside the air passage; and
air in the room is suctioned into the air-conditioner casing via the air passage when the air blower blows air toward the room.

22. The air conditioning system according to claim 6, wherein:
the air-conditioner casing includes an outlet port, through which air having the adjusted temperature flows toward the room.
